(19) United States
(12) Patent Application Publication
(10) Pub. No.: US 2005/0262533 A1
(43) Pub. Date: Nov. 24, 2005

(54) User interface having a cycling display of content representations

(75) Inventors: Michael P. Hart, San Francisco, CA (US); James L. Johnson III, San Carlos, CA (US); Garth Anton Lewis, Sunnyvale, CA (US)

Correspondence Address: LEE & HAYES PLLC, 421 W RIVERSIDE AVENUE SUITE 500, SPOKANE, WA, 99201, US

(73) Assignee: Microsoft Corporation

(21) Appl. No.: 10/848,866

(22) Filed: May 19, 2004

(51) Int. Cl. H04N 5/445

(52) U.S. Cl. 725/40; 725/39; 725/87; 725/100

(57) ABSTRACT

A user interface is described having a cycling display of content representations. In an implementation, a user interface includes a cycling display of a plurality of textual representations of a plurality of content items. Each textual representation references a corresponding one of the content items. At least one of the textual representations is selectable by a user to navigate to the referenced corresponding content item. The cycling display of the plurality of textural representations is cycled without user intervention such that at any one particular time during a cycling of the cycling display, at least one of the textural representations is displayed on the cycling display while another one of the textural representations is not displayed on the cycling display.

### TECHNICAL FIELD

The present invention generally relates to the field of content and more larly relates to a user interface having a cycling display of content representations.

### BACKGROUND

Users of clients, such as set-top boxes and computers, have access to an ever increasing variety of content. A user, for example, may receive traditional television programming over a broadcast network by a set-top box for display on a television, as well as pay-per-view movies, video-on-demand (VOD), interactive video games, and so on. Additionally, users of clients are provided with an increasing variety of ways of interacting with the content. A user may watch a television program, order goods or services, and so on. Clients may also be configured to access content that is provided by applications. For example, a user of a client may receive email, write a document utilizing a word processing application, browse the Internet with a browser application, and soon.

Clients may be configured to provide access to this ever increasing variety of content in a variety of different settings. For example, a client may be configured as a desktop computer. The desktop computer may be configured for viewing when the user is located close to a display device, in what may be thought of as a “desktop” or “office” setting because the user is typically seated at a desk when utilizing the desktop computer. When in the desktop setting, for instance, the user may employ a keyboard and mouse to interact with a word processor that is executed on the client, such as to enter text by utilizing the keyboard and navigate through the text by using the mouse. Therefore, a user interface that is provided for use in a desktop setting is typically configured for use when the user is located close to the display device and has access to input devices for navigation and text entry that typically involve the use of a surface, such as a table top, desk, and so on.

A client may also be configured for use in a “casual” setting. For instance, the client may be configured as a set-top box that provides an output of broadcast content for display on a display device, such as a television. The broadcast content is configured for viewing when the viewer is located away from the display device, such as when seated on a couch. To interact with the content, the user may utilize one or more input devices that are configured for use in the casual setting, such as a television remote control (remote control). By configuring the remote control for ease of use in the casual setting, however, the remote control may not include some of the functionality that is provided by input devices that are configured for use in the desktop setting, such as ease of text entry and navigation that is provided by the keyboard and mouse as previously described. Therefore, traditional clients that are configured to provide content in the casual setting may not address the increasing varieties of content that are now available in the casual setting. For example, although the user may view email output by a set-top box, the set-top box may provide a user interface configured for receiving inputs from input devices typically utilized in the desktop setting. Therefore, the user may be forced to utilize input devices that are not conveniently utilized in the casual setting, which may hinder the user's interaction with the content via the user interface.

Accordingly, there is a continuing need for a user interface for use in a casual setting that enables the user to view and interact with the ever increasing varieties of content.

### SUMMARY

A user interface is described having a cycling display of content representations. The content representations may be cycled such that at any one particular time one or more of the plurality of content representations is displayed while another one of the plurality of content representations is not displayed. The cycling of the content representations may be initiated after a predetermined amount of time has elapsed without receiving a user input. For instance, a timer may be initiated after receiving a user input. When the predetermined amount of time has elapsed, as indicated by the timer, the display of the content representations is then cycled, such as displayed in succession. In this way, the cycling of the content representations may be “passive” such that an input is not required from the user to cycle the display of the content representations.

In an implementation, a user interface includes a cycling display of a plurality of textual representations of a plurality of content items. Each textual representation references a corresponding one of the content items. At least one of the textual representations is selectable by a user to navigate to the referenced corresponding content item. The cycling display of the plurality of textual representations is cycled without user intervention such that at any one particular time during a cycling of the cycling display, at least one of the textual representations is displayed on the cycling display while another one of the textual representations is not displayed on the cycling display.

In an additional implementation, a method includes receiving an input at a client to initiate a user interface. The input is received during an output of video content by the client. The user interface is formed for output by the client and for display in a dedicated viewing area of a display device. The user interface, when displayed, includes a video portion for continuing the output of the video content and a representation portion for display of a plurality of representations of a plurality of content items for output by the client.

### BRIEF DESCRIPTION OF THE DRAWINGS

FIG. 1 is an illustration of an environment in an exemplary implementation that includes a content provider that is communicatively coupled to a client over a network.

FIG. 2 is an illustration of an exemplary environment showing a distribution server and the client of FIG. 1 in greater detail.

FIG. 3 is an illustration of an exemplary implementation showing a user interface of FIGS. 1 and 2 in greater detail.

FIG. 4 is a flow diagram illustrating a procedure in an exemplary implementation in which the user interface of FIG. 3 provides a cycled display of content representations when a predetermined amount of time has elapsed without receiving a user input.

FIG. 5 is a flow diagram depicting a procedure in an exemplary implementation in which characteristics of content items that are referenced by a selected content representation are utilized to configure the user interface.

FIG. 6 is a flow diagram depicting a procedure in an exemplary implementation in which an initial display of a content item that is output by a client is continued when the client outputs a user interface.

The same reference numbers are utilized in instances in the discussion to reference like structures and components.

### DETAILED DESCRIPTION

Overview

A user interface having a cycling display of content representations is described. As previously described, a user of a client, such as a set-top box, may have access to content from a variety of sources. The user, for instance, may receive a traditional broadcast of content, which may also be stored on the client itself for later access. In this example, the client is configured as a digital video recorder (DVR) that may playback the stored content, such as a television program, whenever the user desires to watch the content. In another example, the client may communicate with a head end that may store content when requested to do so by the user of the client, in what may be referred to as a network digital video recorder (NDVR). The content stored at the head end may then be communicated to the client for playback when desired. In a further example, the head end may be configured as a video-on-demand system. In such a system, the head end may also provide stored content, when requested, to the client. In yet another example, the client may access content from a computer readable medium, such as from a digital video disc (DVD).

To access and navigate through this variety of content, the client may output a user interface having a plurality of content representations. Each of the representations references a corresponding content item, such as a headline that references a corresponding news article, a title that references a pay-per-view (PPV) movie, and so on. The user may select the content representation to navigate to the corresponding content item. Through use of the content representations, the user may then decide whether to view a particular content item selected from a plurality of content items without having to view each content item separately.

The user interface, however, may utilize a significant number of content representations to display even just a portion of the content representations for the corresponding content items that are available on the client. Traditional techniques that were utilized to display such a significant number of content representations reduced the display size the content representations so that a greater number of content representations could be displayed at any one particular time. Even then, however, there may be a greater number of content representations than there is available area on the display device in which to display them. Therefore, in such instances, traditional techniques required the user to actively navigate through the content representations by providing inputs from an input device, such as by scrolling through the content representations by using a mouse.

Reducing the displayed size of content representations and requiring the use of inputs from a user to view the content representations, however, may not be suitable for use in the casual settings. For instance, a user sitting on a couch that is ten feet away from a display device may not be able to see a content representation having a reduced size. Additionally, the user may not have ready access to input devices typically used to navigate through the display of content representations. Alternatively, the user may not wish to actively search navigate through content representations even if appropriate input devices are available, such as when the user is viewing other content, such as a video.

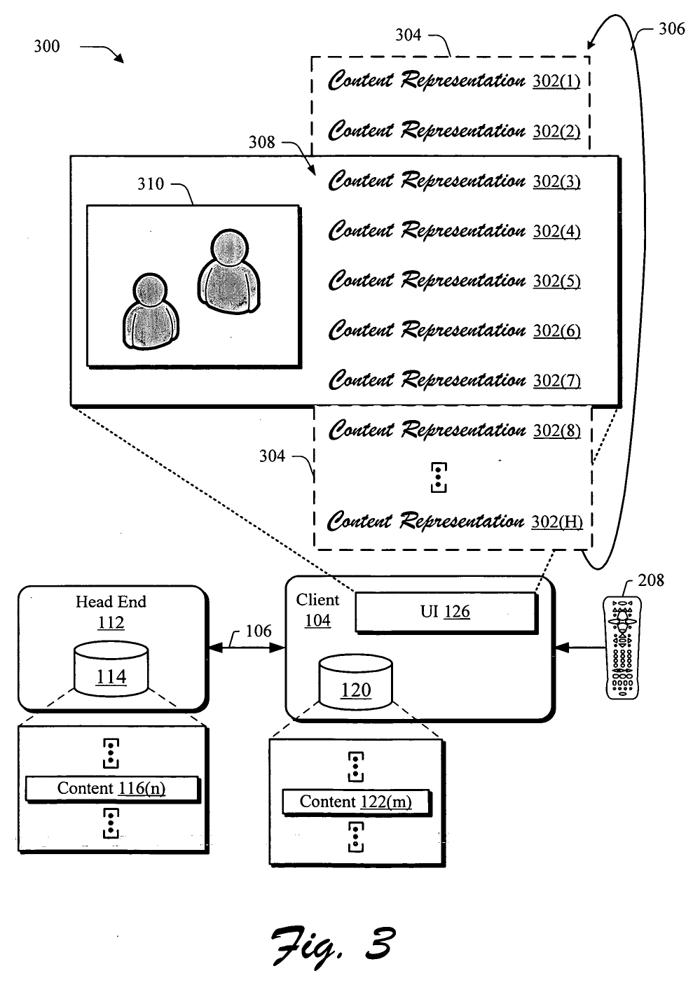

In an implementation, a user interface is provided having a cycling display of content representations. The content representations may be cycled such that at any one particular time one of the plurality of content representations is displayed while another one of the plurality of content representations is not displayed. Additionally, the cycling of the content representations may be initiated after a predetermined amount of time has elapsed without receiving a user input. For instance, a timer may be initiated after receiving a user input for selecting a genre of content representations for viewing, such as sporting events. Content representations of the sporting events are then displayed in the user interface such that the user may locate a particular sporting event. When the predetermined amount of time has elapsed, as indicated by the timer, the display of the content representations of the sporting events is then cycled, such as displayed in succession. In this way, the cycling of the content representations may be “passive” such that an input is not required from the user to cycle the display of the content representations. Further discussion of the cycling of content representations may be found in relation to FIG. 3.

Exemplary Environment

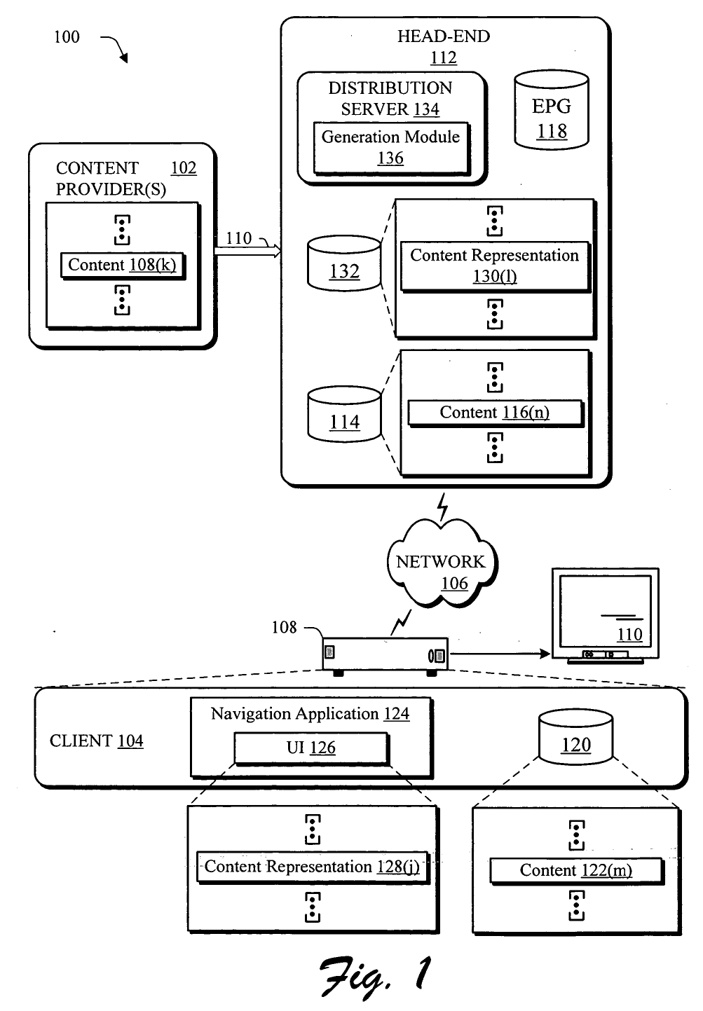

FIG. 1 is an illustration of an environment 100 in an exemplary implementation that includes a content provider 102 that is communicatively coupled to a client 104 over a network 106. The client 104 may be configured in a variety of ways. For example, the client 104 may be configured as a computer that is capable of communicating over the network 106, such as a set-top box 108 communicatively coupled to a display device 110 as illustrated, a mobile station, an entertainment appliance, a broadcast enabled computer, a wireless phone, and so forth. The client 104 may range from a full resource device with substantial memory and processor resources (e.g., television enabled personal computers, television recorders equipped with hard disk) to a low-resource device with limited memory and/or processing resources (e.g., traditional set-top boxes). The client 104 may also relate to a person and/or entity that operates the client. In other words, client 104 may describe a logical client that includes a user and/or a machine. Although one client 104 is illustrated, a plurality of clients may be communicatively coupled to the network 106. The network 106 is illustrated as the Internet, and may include a variety of other networks, such as an intranet, a wired or wireless telephone network, a broadcast network with a backchannel to provide two-way communication, and so forth.

The content provider 102 includes a plurality of content 108(k), where “k” can be any integer from 1 to “K”. The content 108(k) may include a variety of data, such as television programming, video-on-demand (VOD), one or more results of remote application processing, and so on. The content 108(k) is communicated over a network 110 to a head end 112. The network 110 may be the same as or different from network 106.

Content 108(k) communicated from the content server 112 over the network 110 is received by the head end 112 and stored in a storage device 114 as content 116(n), where “n” can be any integer from “1” to “N”. The content 116(n) may be the same as or different from the content 108(k) received from the content provider 102. The content 116(n), for instance, may include additional data for streaming to the client 104. For example, the content 116(n) stored in the storage device 114 may include electronic program guide (EPG) data from an EPG 118 database for broadcast to the client 104 utilizing a carousel file system. The carousel file system repeatedly broadcasts the EPG data over an out-of-band (OOB) channel to the client 104 over the network 106. Distribution from the head end 112 to the client 104 may be accommodated in a number of ways, including cable, RF, microwave, digital subscriber line (DSL), and satellite.

The client 104 may be configured in a variety of ways to receive the content 116(n) over the network 106. As illustrated, the client 104 may be configured as a set-top box 108 that is communicatively coupled to a display device 110. The client 104 includes hardware and software to transport and decrypt content 116(n) received from the head end 112 for rendering by the display device 110. Although the client 104 and the display device 110 are illustrated separately, the display device 110 may be integrated into the client 104, such as a television having an internal set-top box, a notebook computer, and so forth. Additionally, although a display device 110 is shown, a variety of other output devices are also contemplated, such as speakers.

The client 104 may also include digital video recorder (DVR) functionality. For instance, the client 104 may include a storage device 120 to record content 116(n) received from the network 106 for output to and rendering by the display device 110. The storage device 120 may be configured in a variety of ways, such as a hard disk drive, a removable computer-readable medium (e.g., a writable digital video disc), and so on. Content 122(m), where “m” can be any integer from “1” to “M”, that is stored in the storage device 120 of the client 104 may be copies of the content 116(n) that was streamed from the head end 112. Additionally, content 122(m) may be obtained from a variety of other sources, such as from a computer-readable medium that is accessed by the client 104, and so on. For example, the content 112(m) may include a home movie that was recorded using a digital video camera and then copied to the storage device 120, may include a digital video disc (DVD) inserted into a DVD drive on the client 104, and so on.

The client 104 includes a navigation application 124 that is executable on the client 104 to control content output on the client 104, such as through the use of one or more “trick modes”. The trick modes may provide non-linear playback of the content 122(m) (i.e., time shift the playback of the content 122(m)) such as pause, rewind, fast forward, slow motion playback, and the like. For example, during a pause, the client 104 may continue to record the content 116(n) in the storage device 120 as content 122(m). The client 104, through execution of the navigation application 124, may then playback the content 122(m) from the storage device 120, starting at the point in time the content 122(m) was paused, while continuing to record the currently-broadcast content 116(n) in the storage device 120 from the head end 112.

When playback of the content 122(m) is requested, the navigation application 124 is executed on the client 104 to retrieve the content 122(m). The navigation application 124 may also restore the content 122(m) to the original encoded format as received from the content provider 102. For example, when the content 122(m) is recorded on the storage device 120, the content 122(m) may be compressed. Therefore, when the navigation application 124 retrieves the content 122(m), the content 122(m) is decompressed for rendering by the display device 110.

The navigation application 124, when executed by the client 104, may provide a user interface 126 for output to and display on the display device 110. The user interface 126 may include a plurality of content representations 128(j), where “j” can be any integer from one to “J”. Each of the content representations 128(j) may be utilized to reference any one particular item of content that is available at the client 104, such as the content 116(n) from the head end, content 122(m) that is accessible locally on the client 104, and so on.

The content representations 1280) may be provided in a variety of ways. For example, the navigation application 124, when executed, may generate the content representations 1280) by examining content that available on the client 104. EPG data is one of many sources of content representation metadata that may be utilized to generate the content representations 1280). Other sources of content representation metadata include local video database metadata, VOD metadata databases, and so on. For example, VOD video metadata may be retrieved as one or more XML files from an HTTP server to supply the content representations. In yet another example, the head end 112 may stream one or more of a plurality of content representations 130(1), where “1” can be any integer from one to “L”, which are stored in a storage device 132 and/or generated locally at the head end 112. For instance, the head end 112 may include a distribution server 134 having a generation module 136. The generation module 136, when executed on the distribution server 134, may examine the content 116(n) and generate the content representations 130(1) for each content item, such as a headline for a news article, a title for a television program, a title for a video clip, and so on. The distribution server 134 of the head end 112 may then stream the content representations 130(1) to the client 104 over the network 106. The streamed content representations 130(1) may then be utilized by the navigation application 124, when executed on the client 104, to generate the UI 126 for output to and rendering by the display device 110.

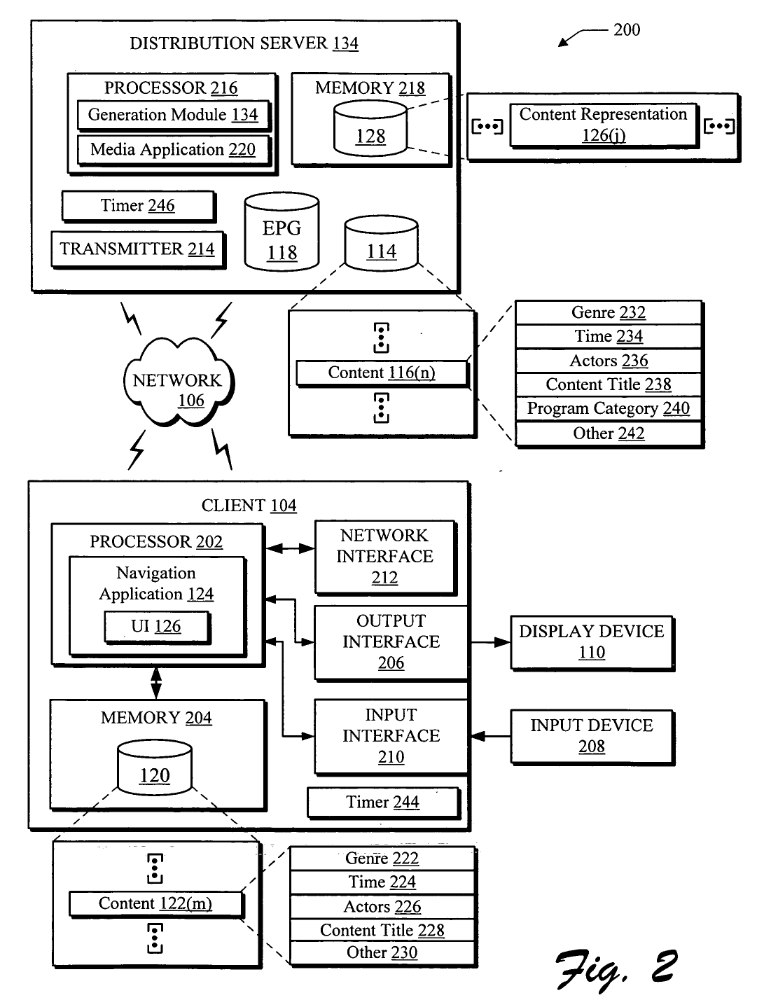

FIG. 2 is an illustration of an exemplary environment 200 showing exemplary implementations of the distribution server 134 and the client 104 of FIG. 1 in greater detail. The client 104 includes a processor 202 and memory 204. The navigation application 124 is illustrated as being executed on the processor 202 and is storable in memory 204. The storage device 120, which is utilized to store the plurality of content 122(m), is illustrated as included in the memory 204. In an additional implementation, the memory 204 may be different from the storage device 120. For example, the storage device 120 may be configured as a hard disk drive and the memory 204 may be configured as RAM, both the memory 204 and the storage device 120 may be configured as RAM, one or both of the memory 204 and the storage device 120 may be configured as removable memory, and so forth. The Storage Device 120 may also be used to store content representations even if the content representation is not a part of the related media content file already in storage. For instance, content representations may be streamed from a head end and cached for display separately from the corresponding content.

The client 104 may obtain content from a variety of sources. For example, the client 104 may execute the navigation application 124 to retrieve content 122(m) from the storage device 120. The retrieved content 122(m) may then be output using an outputs interface 206 for rendering on the display device 110. As previously stated, the navigation application 124, when executed on the processor 202, may provide one or more trick modes for the control of content playback over the output interface 206, such as pause, rewind, fast forward, slow motion playback, and the like.

The client 104, through execution of the navigation application 124, is also capable of requesting content 116(n) from the distribution server 134 over the network 106. For instance, the navigation application 124, when executed on the processor 202, may receive an input from an input device 208 at an input interface 210. The navigation application 124, in response to the input, may then form and send a request via the network 106 to the distribution server 134 to request content 116(n) for streaming over the network 106. The client 104 includes a network interface 212 to communicatively couple the client 104 with the distribution server 134. The distribution server 134 includes the storage device 114 having the plurality of content 116(n) for streaming over the network 106.

In an implementation, the network 106 is a VOD network, which is a type of broadcast network. For example, the network 106 may support two-way communication between the distribution server 134 and the client 104. The network 106 can include any type of network that can support a two-way connection between the distribution server 134 and the client 104. Additionally, the network 106 can be any type of network, using any type of network topology and any network communication protocol, and can be represented or otherwise implemented as a combination of two or more networks including, for example, microwave, satellite, and/or data networks, such as the Internet. Furthermore, the network 106 may be capable of transmitting and receiving wired or wireless media using any broadcast format or broadcast protocol.

The distribution server 134 also includes a transmitter 214. The transmitter 214 provides distribution of the content 116(n) from the storage device 114, across the network 106, to the client 104. In alternate implementations, the distribution server 134, storage device 114, and transmitter 212 may be implemented as one or more distinct components, locally as part of the head end 112 and/or content provider 102 of FIG. 1, or remotely as part of another distinct system.

The distribution server 134 includes a processor 216, memory 218, and the generation module 136, which is illustrated as being executed on the processor 216 and is storable in memory 218. The storage device 128 is illustrated as included in memory 218, but may also be configured as separate from memory 218, such as configured, respectively, as a hard disk drive and RAM. The distribution server 134 is also illustrated as including a media application 220 that, when executed on the processor 216, controls distribution of the content 116(n) over the network 106. For instance, the media application 220 may receive the request from the client 104 to output the content 116(n). The media application 220 processes the request, such as to determine whether the client 104 is permitted to receive the content 116(n), obtain billing information from the client 104, locate the requested content from the plurality of content 116(n), and so on. If the client 104 is permitted to receive the content 116(n), the media application 220 may be executed to stream the content 116(n) to the client 104 over the network. Additionally, although the generation module 136 is illustrated as software that is illustrated as separate from the media application 220, the media application 220 and the generation module 136 may be implemented together as a single application.

Each content item for output by the client 104 may have one or more of a plurality of characteristics, such as genre 222 (e.g., sporting event, drama, and so forth), time 224 (e.g., time the content 122(m) was recorded, time for playback, and so on), actors 226 included in the content 122(m), content title 228, and other 230 descriptive data. For example, the other 230 descriptive data may describe a program category, a content owner (e.g., a TV production company, movie studio, and so on) where the content 122(m) is stored (e.g., network address of the client 104), and so on. The characteristics may be described in a variety of ways, such as by corresponding metadata for each respective one of the plurality of content 122(m). Likewise, content 116(n) may also include similar characteristics specified through metadata, such as genre 232, time 234, actors 236, content title 238, program category 240, and other 242 descriptive data.

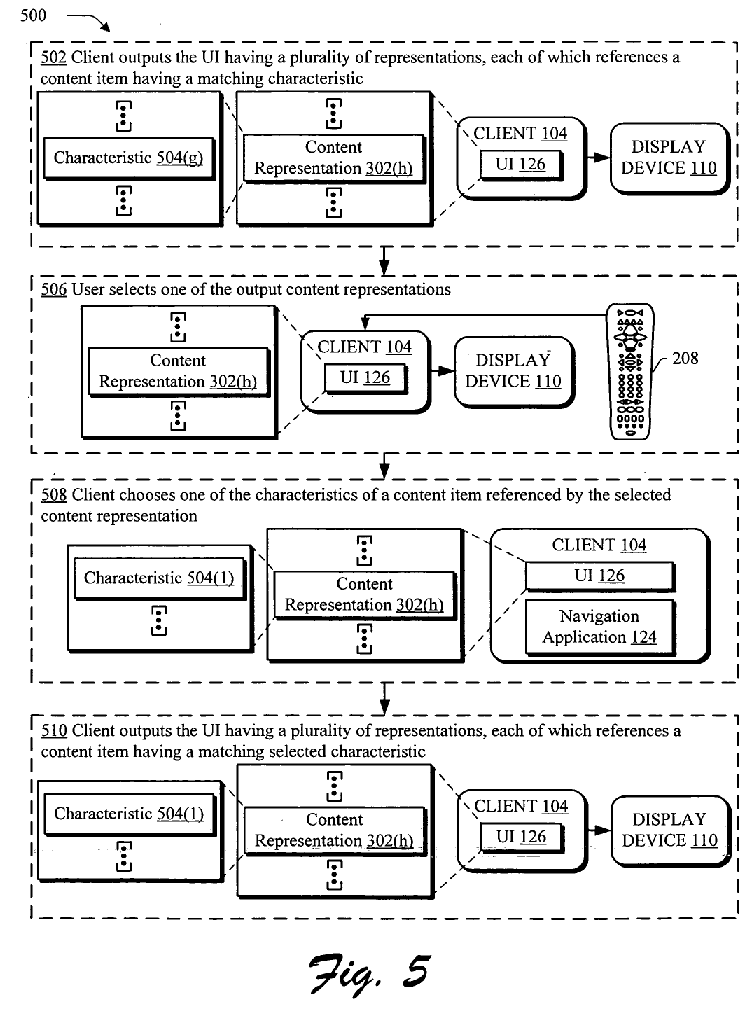

The UI 126 may be configured for output by the navigation application 124 to include a display of content representations having one or more of the characteristics in common. For example, content representations of content in a particular genre 222 may first be output for viewing by a user. Upon selection of one or more of the content representations, content representations having a characteristic in common with the selected content representation may then be output in the UI 126, such as content that is available for output at a particular time 224. Further discussion of the use of characteristics in the UI 126 may be found in relation to FIG. 5.

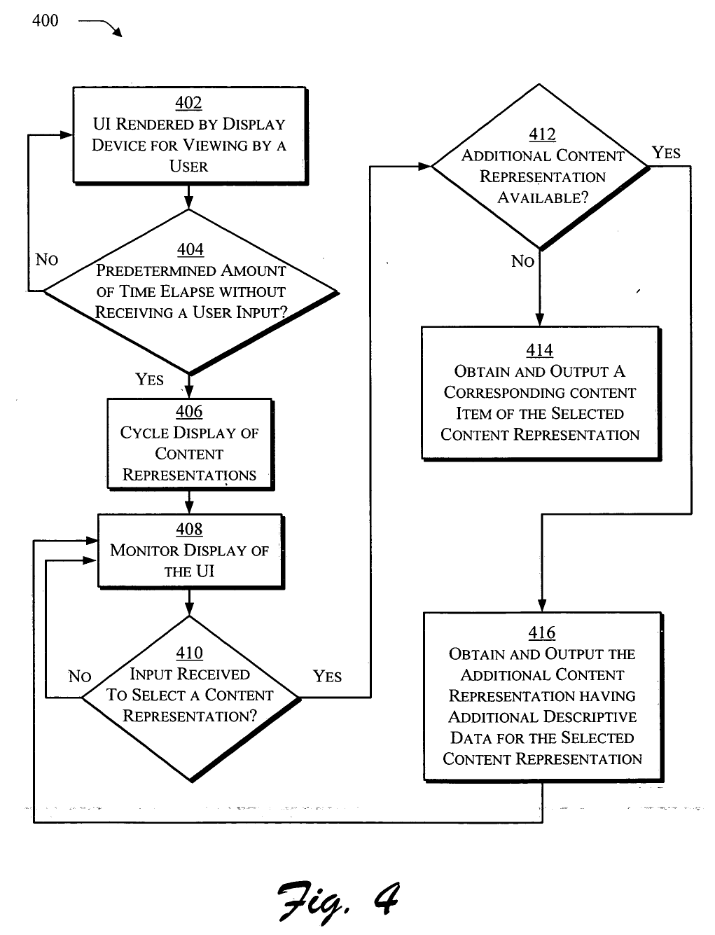

The UI 126, when output by the client 104, may provide a cycling display of content representations for viewing by the user. To provide the user with a sufficient amount of time to view an initial display of the content representations, a timer 244 may be utilized to initiate the cycling. For example, the navigation application 124 may output the UI 126 for viewing by the user. When output, the navigation application 124 may monitor the timer 244 such that if a predetermined amount of time has elapsed, during which, an input has not been received at the input interface 210 from the input device 208, the content representations of the UI 126 are cycled. In this way, the user may view more content representations than would otherwise be possible in a display area of the display device 110. Additionally, the cycling may be provided without requiring a user input, thereby providing a passive viewing experience that is consistent with a casual setting. Although the timer 220 is illustrated as separate from the processor 214 and memory 216, the timer 146 may be implemented as hardware and/or software that is executed on the processor 214. In another implementation, the client 104 receives a timing indication from over the network 106 from a timer 246 located at the distribution server 134. Further discussion of the user of a timer 220 for cycling a display of content representations may be found in relation to FIG. 4.

FIG. 3 is an illustration of an exemplary implementation 300 showing the user interface 126 (UI) of FIGS. 1 and 2 in greater detail. The UI 126 may be utilized to enable a user to view a plurality of content representations 302(1)-302(H). One or more of the content representations 302(1)-302(H) are selectable by a user through use of the input device 208, which in this instance is illustrated as a television remote control, to navigate to a respective content item. For example, content representation 302(3) may reference a news article such that when the user selects the content representation 302(3), the referenced news article is output in the UI 126. In another example, content representation 302(4) may reference a video clip such that when the user selects the content representation 302(4), the video clip is output for display without displaying the UI 126.

The display of the content representations 302(1)-302(H) may be cycled so that a user may view the content representations 302(1)-302(H) in a passive manner such that an input is not required from the user to view each of the plurality of content representations 302(1)-302(H). For example, at any one particular time, one or more content representations may be output for display in conjunction with the UI 126 while another one of the plurality of representations is not output for display. An example of this is illustrated in FIG. 3 as content representations 302(3)-302(7) being depicted within the solid box of the UI 126 while content representation 302(1)-302(2), 302(8)-302(H) are depicted within the phantom boxes 304.

In an implementation, the cycling of the content representations 302(1)-302(H) may be repeated after each of the content representations 302(1)-302(H) is output for display, i.e. rendering, by the display device 110 of FIGS. 1 and 2. The repeated cycling is illustrated in FIG. 3 through the use of the curved arrow 306. It should be noted that cycling is not limited to repeating the display of each of the content representations 302(1)-302(H). For example, as illustrated, the display of the content representations 302(1)-302(H) may be cycled such that at one particular point in time content representations 302(3)-302(7) are displayed while another one of the content representations, e.g. 302(8), is not displayed. After and/or before that particular point in time, however, one or more of the other content representations (e.g., content representations 302(1)-302(2), 302(8)-302(H)) is displayed. The display of the cycling of the content representations 302(1)-302(H) may be cycled in a variety of ways, such as scrolling, fade-in/fade-out, dissolving, and so forth.

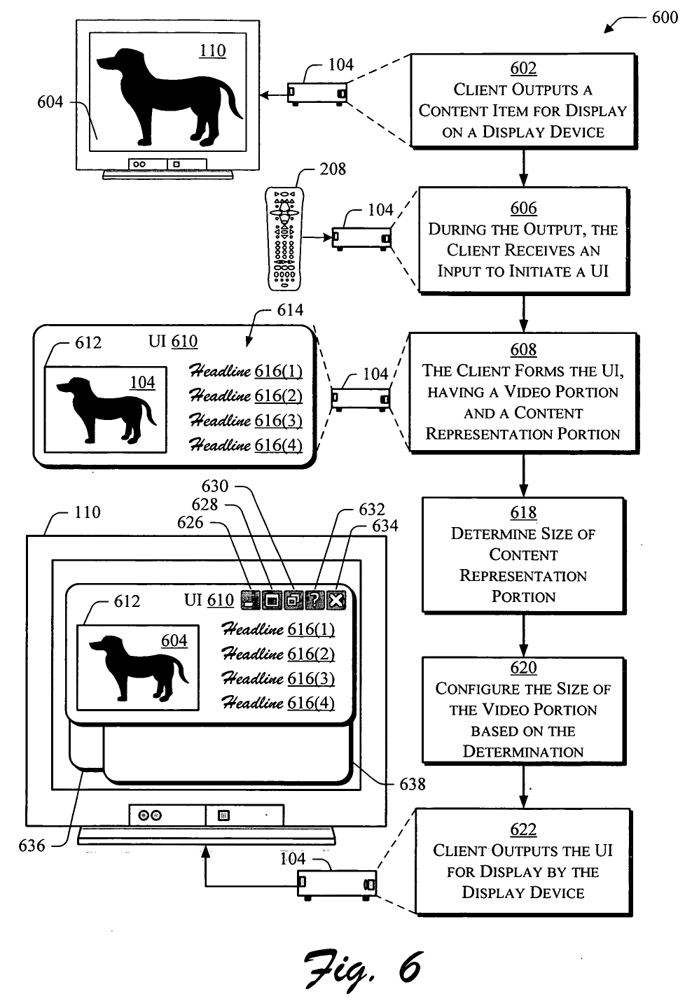

The UI 126 may be configured in a variety of ways to include the content representations 302(1)-302(H). For example, as illustrated in FIG. 3, the UI 126 includes a content representation portion 308 and a video portion 310. As illustrated, the content representation portion 308 is utilized to display the content representations 302(1)-302(H). The video portion 310 may be utilized to display video content. For instance, the video portion 310 may utilize a predetermined area of the UI 126, when output, that includes video content that was being output by the client 104 when the UI was initiated. Thus, the UI 126 may be utilized to continue an output of video content such that the user's viewing experience is not interrupted when utilizing the UI 126. Further discussion of the video portion 310 and the continuation of an output of video content using the video portion 310 may be found in relation to FIG. 6.

Exemplary Procedures

FIG. 4 is a flow diagram illustrating a procedure 400 in an exemplary implementation in which the UI 126 of FIG. 2 provides a cycled display of content representations when a predetermined amount of time has elapsed without receiving a user input. At block 402 a UI is rendered by the display device for viewing by a user. The rendered UI provides a display having a plurality of content representations, each of which references a particular content item. For example, a content representation may be configured as a title of a movie, a song, or a television program, a headline of a news article, a description of a video clip, and so forth.

At decision block 404, a determination is made as to whether a predetermined amount of time has elapsed without receiving a user input. For example, the UI, when displayed, may include a first grouping of content representations that are selected from a plurality of content representations. To give the user sufficient time to view the first grouping of content representations, a timer may be monitored to determine if a predetermined amount of time has elapsed for the user to view the first grouping of content representations. The timer, for instance, may be reset in response to each input received from the user. In another example, a start time may be recorded from a timer when an input is received. Whether the predetermined amount of time has elapsed may then be determined by subtracting the current time from the recorded start time. As previously described, the timer may be implemented in a variety of ways, such as through hardware and/or software that is located at the client 104 and/or remotely over the network 106 at the head end 112 of FIG. 2. For example, the timer 244 of the client 104 FIG. 2 may operate by receiving timing signals sent from the timer 246 using the transmitter 214 of the distribution server 134 of FIG. 2.

When the predetermined amount of time has elapsed without receiving a user input (block 404), the display of content representations of the UI is cycled (block 406). The display of content representations may be cycled in a variety of ways. For example, the content representations may be cycled in a scrolling list such that content representations are concurrently added to and removed from the display. In another example, a subsequent grouping of content representations may “fade-in” to replace a previous grouping of content representations that were displayed on a display device. In a further example, content representations are displayed in a “ticker” format across the display. A wide variety of other techniques may also be utilized to provide a cycling display of content representations.

At decision block 410, a determination is made as to whether an input was received to select a particular content representation. For example, the user may utilize the input device 208 of FIG. 2 to highlight a particular content representation and select the particular content representation by utilizing an “enter” button. At decision block 412, a determination is made as to whether an additional content representation is available. For example, the selected content representation may be configured as the title of a movie. The selected content representation may reference an additional content representation that provides a detailed description of the movie, such as a plot line, actors in the movie, and so forth. Thus, the user may be provided with additional descriptive information to make an informed decision about consuming the particular content item without having to view the actual content item.

The additional descriptive information may also be selectable by a user to navigate to the corresponding content item. For instance, if an additional content representation is not available (block 412), the corresponding content item of the selected content representation is obtained and output by the client (block 414). If an additional content representation is available (block 412), the additional content representation having the additional descriptive data for the selected content representation is obtained and output (block 416). The procedure 400 may then proceed back to block 408 such that the display of the UI having the additional content representation is monitored. In this way, hierarchical content representations may be utilized to provide additional descriptive information that describes a particular content item. Thus, a user may navigate from an initial content representation through a hierarchy of additional content representations to cause the client to output the particular content item.

FIG. 5 is a flow diagram depicting a procedure 500 in an exemplary implementation in which characteristics of content items that are referenced by a selected content representation are utilized to configure the UI. At block 502, the client 104 outputs the UI 126 having the plurality of representations 302(h), where “h” can be any integer from one to “H”, for display by the display device 110. Each content representation 302(h) has a corresponding content item that has a plurality of characteristics 504(g), where “g” can be any integer from one to “G”. Therefore, each content representation 302(h) is illustrated in FIG. 5 as having the plurality of characteristics 504(g) that correspond to the content item referenced by each respective content representation 302(h). The content representations 504(g), for instance, may be. output that reference content items that having matching start times. A wide variety of characteristics 504(g) may be utilized that describe the respective content item, such as a title, a story line, a textual description, a production credit, a critic's opinion, a review, a recommendation, a duration, a start time, a stop time, a genre, a rating, a performer, a director, and so on. User specific metadata may also be utilized. For example, user specific metadata may be used to specify whether or not the user has watched/viewed, recorded, or downloaded the content for local on-demand playback. This additional content representation metadata could be available in a user database on the client and/or server. The user specific metadata can be embedded in the other content representation metadata or maintained separately and linked through common keys, such as a media identifier.

At block 506, the user selects one of the output content representations 302(h). For example, the user may utilize an input device 208, which is illustrated as a remote control, to highlight the display of content representation 302(h) and select the display by utilizing an enter button. The client 104 receives an input from the input device 208 which may then be utilized to determine that the content representation 302(h) was selected.

At block 508, the client 104 chooses one of the characteristics of the selected content item 302(h). The client 104, for instance, may execute the navigation application 124 that includes a decision tree for selecting a particular characteristic which may be based on a wide variety of factors. For example, the decision tree may determine that if the genre is “sporting event” then other content representations of sporting events are selected, but if the genre is “drama” then other content representations having matching start times are selected. In this way, the navigation application 124, when executed, may choose a particular characteristic 504(1) based on one or more values of the characteristic for the content item referenced by the selected content representation. In this example, the navigation application 124 chooses characteristic 504(1) of the content item referenced by the selected content representation 302(h).

At block 510, the client 104 outputs the UI 126 having content representations 302(h) which reference content items that have the matching characteristic 302(1), one to another. In an implementation, the content representations 302(h) reference content items that having matching characteristics as output at block 502 and matching characteristics as chosen at block 508. For example, the content representations output at block 502 may reference content items having a matching program category, e.g., world news. The characteristic chosen at block 508 may be utilized to further constrain those content representations, such as by choosing a characteristic that specifies a person involved in the content items, e.g., athlete, actor, and so on. Thus, the user may sort through the plurality of content representations 302(h) through use of the characteristics 504(g). In another implementation, the characteristics at block 508 do not necessarily further constrain the content representations 302(h) output at block 502. For instance, the content representations output at block 510 are not dependent on the characteristics of the content representations output at block 502 such that the content representations output at block 510 may or may not include content representations that were output at block 502.

FIG. 6 is a flow diagram depicting a procedure 600 in an exemplary implementation in which an initial display of a content item that is output by a client is continued when the client outputs the UI 126 of FIG. 3. At block 602, the client 104 outputs a content item 604 for display on a display device 110. In this example, the content item 604 is video content which, when displayed on the display device 110, is illustrated as including a display of a dog. The content item 604 may be obtained form a variety of sources, such as streamed from the head end 112 of FIG. 1, stored locally on the client 104 (e.g., stored in the storage device 120 of FIG. 1), and so on.

At block 606, during the output of the content item 604, the client 104 receives an input to initiate a UI. For example, the user may utilize the remote control 208 which provides an input to cause the client 104 to output a UI that, when output, enables the user to view other content items that are related to the content item 604 being output at block 602. In another example, the user provides the input to cause the client 104 to output a UI so that the user can select a different content item for viewing.

At block 608, the client forms the UI 610 having a video portion 612 and a content representation portion 614. The content representation portion 614 of the UI 610 includes a plurality of content representations, which in this instance are illustrated as headlines 616(1)-616(4). Each of the headlines 616(1)-616(4) reference a corresponding news article or news video clip. The video portion 612 of the UI 610 is utilized to continue the output of the content item 604. In this way, the user may continue to interact with the content item 604 that was output at block 602 and view additional information. For example, the headlines 616(1)-616(4) may be related to the content item 604, such as by having similar characteristics as previously described, such as in the same genre and so on. In another example, the headlines 616(1)-616(4) are not related to the content item 604 to provide the user with a display of content representations that unrelated to the content item 604.

The video portion 612 of the UI 610 may be configured in a variety of ways. For example, at block 618 a size of the content representation portion 614 of the UI 610 is determined. The content representation portion 614, for instance, may be configured to display varying amounts of content representations and therefore the size of the content representation portion 614 may be determined based on the size and/or number of the content representations for output. At block 620, the size of the video portion 612 is configured based on the determination (block 618). In this way, the video portion 612 of the UI 610 may be optimized to provide a maximum viewing area based on the available display space of the UI 610 that is not consumed by the content representation portion 614.

At block 622, the client 104 outputs the UI 610 for display by the display device 110. In the illustrated implementation of FIG. 6, the UI 610 is displayed in a dedicated portion 624 of the total display area of the display device 110. The dedicated portion 624, for instance, may include a variety of display controls, such as minimize 626, maximize 628, restore down 630, help 632, close 634, and so on, which control the dedicated portion 624 of the display provided by the display device 110. The dedicated portion 626 may be displayed with other dedicated portions 636, 638 having similar display controls. Thus, each dedicated viewing portion 624, 636, 638 provides a separate viewing area on the display device 110 which may be resized (e.g., stretched), and may also be utilized to provide multitasking. Although a UI has been described that provides a display that may be shared by a variety of media types, the UI can also support multiple media types by multitasking multiple displays.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A user interface comprising a cycling display of a plurality of textual representations of a plurality of content items, wherein:
each said textual representation references a corresponding said content item;
at least one said textual representations is selectable by a user to navigate to the referenced said corresponding content item; and
the cycling display of the plurality of textual representations is cycled without user intervention such that at any one particular time during a cycling of the cycling display, at least one said textual representation is displayed on the cycling display while another said textual representation is not displayed on the cycling display.

2. A user interface as recited in claim 1, wherein the cycling display of the plurality of textual representations is cycled such that after each said textual representation has been displayed on the cycling display, at least one said textual representation is displayed again on the cycling display.

3. A user interface as recited in claim 1, wherein the one or more said textual representations are for selection by a user to navigate to the referenced corresponding said content item via another said textual representation having additional descriptive data that:
describes the referenced corresponding said content item; and
is not included in the one or more said representations.

4. A user interface as recited in claim 1, wherein at least one said content item is video.

5. A user interface as recited in claim 1, wherein at least one said content item includes text.

6. A user interface as recited in claim 1, wherein at least one said content item is a news article and the corresponding said textual representation that references the at least one said content item is a headline of the news article.

7. A user interface as recited in claim 1, further comprising a video portion for continuing an output of one said content item which was output during receipt of an input from the user to initiate execution of the user interface on a client.

8. A user interface as recited in claim 1, wherein:
a first grouping of said textual representations have a matching first characteristic, one to another; and
at least one said textual representation of the first grouping is selectable by the user such that, when selected, a second grouping of said textual representations having a matching second characteristic, one to another, of the selected said textual representation are displayed on the cycling display.

9. A user interface as recited in claim 8, wherein the characteristics are selected from the group consisting of:
a title;
a story line;
a textual description;
a production credit;
a critic's opinion;
a review;
a recommendation;
a duration;
a start time;
a stop time;
a genre;
a rating;
a performer;
a director;
user specific metadata; and
a combination of the foregoing.

10. A user interface comprising a plurality of representations on a display, wherein:
each said representation references a corresponding content item;
each said content item has a plurality of characteristics;
a first grouping of said representations has a matching first characteristic, one to another;
the first grouping of said representations is displayable in succession on the display without user interaction such that at least one said representation in the first grouping is displayed while another said representation in the first grouping is not displayed;
at least one said representation of the first grouping is selectable by user interaction to cause a second grouping of said representations to be displayed on the display; and
each said representation in the second grouping references a respective said content item having a matching second said characteristic, one to another.

11. A user interface as recited in claim 10, wherein the second said characteristic is different from the first said characteristic.

12. A user interface as recited in claim 10, wherein:
the second said characteristic is different from the first said characteristic; and
each said content item referenced in the second grouping does not have the first said characteristic that matches, one to another.

13. A user interface as recited in claim 10, wherein:
the second said characteristic is different from the first said characteristic; and
each said content item referenced in the second grouping has the first said characteristic that matches, one to another.

14. A user interface as recited in claim 10, wherein each said characteristic is selected from the group consisting of:
a title;
a story line;
a textual description;
a production credit;
a critic's opinion;
a review;
a recommendation;
a duration;
a start time;
a stop time;
a genre;
a rating;
a performer;
a director;
user specific metadata; and
a combination of the foregoing.

15. A user interface as recited in claim 10, wherein at least one said content item is a news article and the said representation that references the at least one said content item is a headline of the news article.

16. A user interface as recited in claim 10, wherein at least one said content item is available from a network connection.

17. A user interface as recited in claim 10, wherein at least one said content item is stored locally on a client that outputs the user interface.

18. A method comprising:
receiving an input at a client to initiate a user interface, wherein the input is received during an output of video content by the client; and
forming the user interface for output by the client, wherein the user interface:
is for display in a dedicated viewing area of a display device; and
when displayed, includes:
a video portion for continuing the output of the video content; and
a representation portion for display of a plurality of textual representations of a plurality of content items for output by the client.

19. A method as recited in claim 18, wherein:
each said textual representation references a corresponding said content item; and
one or more said textual representations, when output, are selectable by a user to navigate to the referenced corresponding said content item.

20. A method as recited in claim 18, wherein the dedicated viewing area includes one or more controls that are configured to at least one of close, resize, maximize, minimize, or hide the dedicated viewing area.

21. A method as recited in claim 18, wherein the video content is streamed from a head end to the client.

22. A method as recited in claim 18, wherein the video content is stored locally on the client.

23. A method as recited in claim 18, further comprising outputting the formed user interface for display by a display device.

24. A method as recited in claim 18, further comprising:
receiving a second input, at the client, to select one said textual representation; and
outputting, in the representation portion of the user interface, an additional said representation, wherein the additional said textual representation is selectable by the user to navigate to the referenced corresponding said content item of the selected one said textual representation.

25. One or more computer readable media comprising computer executable instruction that, when executed on a computer, direct the computer to perform the method as recited in claim 18.

26. A method comprising outputting a user interface by a client for display by a display device, wherein:
the user interface, when displayed, includes a plurality of representations of a plurality of content items;
each said representation references a corresponding said content item;
one or more said representations, when displayed, are selectable by a user to navigate to the referenced corresponding said content item; and
when the outputting has occurred for a predetermined amount of time, during which, an input has not been received from a user, the method further includes cycling one or more of the plurality of representations for output in the user interface.

27. A method as recited in claim 26, wherein the cycling is performed such that after each said content representation has been output, at least one said content representation is output again.

28. A method as recited in claim 26, wherein the cycling is performed such that at any one particular time, at least one said representation is not displayed while another said representation is displayed.

29. A method as recited in claim 26, wherein the one or more said representations are selectable by the user to navigate to the referenced corresponding said content item via another said representation having additional descriptive data that:
describes the referenced corresponding said content item; and
is not included in the one or more said representations.

30. A method as recited in claim 26, wherein:
each said representation has a plurality of characteristics;
a first grouping of said representations is for output that have a matching first said characteristic, one to another; and
at least one of the first grouping of said representations is for selection by the user such that, when selected, a second grouping of said representations are output that have a matching second said characteristic, one to another, of the selected said representation.

31. A method as recited in claim 30, wherein the characteristics are selected from the group consisting of:
a title;
a story line;
a textual description;
a production credit;
a critic's opinion;
a review;
a recommendation;
a duration;
a start-time;
a stop time; a genre;
a rating;
a performer;
a director;
user specific metadata; and
a combination of the foregoing.

32. One or more computer readable media comprising computer executable instruction that, when executed on a computer, direct the computer to perform the method as recited in claim 26.

33. A client comprising:
network interface means for providing a communicative coupling to a network;
an output interface means for providing a communicative coupling to a display device;
means for processing; and
memory means for maintaining a navigation application this is executable on the processor to provide an output of a user interface at the output interface means, wherein:
the user interface, when output, includes a display of a plurality of representations of a plurality of content items that are cycled without user intervention such that at any one particular time, at least one said representation is displayed while another said representation is not displayed;
each said representation references a corresponding said content item;
at least one said content item is for receipt at the network interface means; and
one or more said representations are for selection by a user to navigate to the referenced corresponding said content item.

34. A client as recited in claim 33, wherein the at least one said content item is a television program.

35. A client as recited in claim 33, wherein another said content item is stored in the memory means.

36. A client as recited in claim 33, wherein the plurality of representations are cycled when an input has not been received from the user for a predetermined amount of time.

37. A client as recited in claim 33, wherein the navigation application is further executable on the processing means to:
receive an input to initiate the user interface, wherein the input is received during an output of a particular said content item at the output interface means; and
form the user interface for output at the output interface means, wherein the user interface:
is for display in a dedicated viewing area of a means for displaying; and
when displayed, includes a video portion for continuing the output of the particular said content item.

38. A client as recited in claim 33, wherein the navigation application is further executable on the processing means to:
cycle a first grouping of said representations, wherein:
each said representation of the first grouping references a respective said content item having a matching first said characteristic, one to another; and
at least one said representation of the first grouping:
is for selection by a user; and
when selected, causes a second grouping of said representations to be displayed, each of which referencing a respective said content item having a matching second said characteristic, one to another.

39. A client as recited in claim 38, wherein each said characteristic is selected from the group consisting of:
a title;
a story line;
a textual description;
a production credit;
a critic's opinion;
a review;
a recommendation;
a duration;
a start time;
a stop time;
a genre;
a rating;
a performer;
a director;
user specific metadata; and
a combination of the foregoing.

40. A client as recited in claim 33, further comprising an input interface means for receiving an input from an input device, wherein the input is for selecting the one or more said representations to navigate to the referenced corresponding said content item.
